(19) United States
(12) Patent Application Publication
(10) Pub. No.: US 2025/0164789 A1
(43) Pub. Date: May 22, 2025

(54) OPTICAL MODULE, NEAR-TO-EYE DISPLAY DEVICE, AND OPTICAL SUBSTRATE

(71) Applicant: GYGES LABS PTE. LTD., Kaki Bukit (SG)

(72) Inventors: Yewei XIAO, SHENZHEN (CN); Jieyang JIA, SHENZHEN (CN); Xudong DENG, SHENZHEN (CN); Yingnan ZHAI, SHENZHEN (CN); Xiongxiong ZHENG, SHENZHEN (CN)

(73) Assignee: GYGES LABS PTE. LTD., Kaki Bukit (SG)

(21) Appl. No.: 18/770,717

(22) Filed: Jul. 12, 2024

(30) Foreign Application Priority Data
Nov. 22, 2023 (CN) 202311582204.6

(51) Int. Cl. G02B 27/01

(52) U.S. Cl. CPC G02B 27/0172; G02B 2027/0123; G02B 2027/0152; G02B 27/0176

(57) ABSTRACT

An optical module, a near-to-eye display device, and an optical substrate are disclosed. At least one first distance is defined between a first intersection line and a periphery of a second reflective surface along a first direction. At least one second distance is defined between the first intersection line and the periphery of the second reflective surface along a second direction. The at least one first distance is less than the at least one second distance. At least one third distance is defined between a second intersection line and a periphery of an exit surface along the first direction. At least one fourth distance is defined between the second intersection line and the periphery of the exit surface along the second direction. The at least one third distance is less than the at least one fourth distance.

### CROSS-REFERENCE TO RELATED APPLICATIONS

This application claims priority to Chinese Patent Application No. 202311582204.6, filed on Nov. 22, 2023 in the National Intellectual Property Administration of China, the contents of which are herein incorporated by reference in their entireties.

### TECHNICAL FIELD

The present disclosure relates to the field of augmented reality technology, and in particular to an optical module, a near-to-eye display device, and an optical substrate.

### BACKGROUND

Augmented Reality (AR), a technology that “seamlessly” integrates real world information and virtual world information, processes certain information that is difficult to be experienced in a real world through an image, data, optical, and other technical processing so that people can obtain a mixed experience of reality and virtuality. Since the AR technology is able to superimpose virtual objects or images on a real environment, the AR technology bears great potential for applications in many fields. In recent years, various smart devices, such as smart glasses, helmets, head-up displays, and the like, have become increasingly popular.

Since a head-mounted device is often worn for a long period, the smaller and lighter head-mounted device is a goal that major manufacturers are constantly pursuing. Existing modules by a prism technology, and etc. tend to be relatively large in weight and volume, and existing modules by an optical waveguide technology is less optically efficient. The existing technologies mentioned above may greatly change an appearance, structure, and etc. of original glasses or head-mounted devices, for example, nearsighted glasses, farsighted glasses, safety glasses, sunglasses, and other traditional glasses or helmets. Therefore, it may be extremely difficult to combine solutions in the existing technologies with the existing traditional glasses, helmets and other head-mounted devices. In addition, as a device that is configured to transmit contents to a retina of human eyes, taking the head-mounted device as an example, it is very important to make sure that the contents are clearly and completely presented in a field of view in the retina of human eyes. Under a mixed scenario of virtuality and reality, a higher quality image and a higher light effect are very important, and acquiring virtual information content in a relatively larger field of view also becomes an increasingly important functional requirement.

### SUMMARY OF THE DISCLOSURE

The present disclosure provides an optical module, a near-to-eye display device, and an optical substrate, in order to address at least one technical problem mentioned above. The present disclosure may realize a different field of view in a different direction. Some other technical effects of the present disclosure may be illustrated in the following embodiments of the present disclosure.

In a first aspect, an optical module is provided by some embodiments of the present disclosure. The optical module may be applied to a near-to-eye display device and may include a substrate, a first reflective surface, a second reflective surface, an incident surface, an exit surface, and a rounded side surface. The substrate includes a first end and a second end disposed in opposite to the first end. The first reflective surface is disposed on the first end of the substrate and is configured to reflect light. The second reflective surface is disposed on the second end of the substrate and is configured to receive the light reflected by the first reflective surface and reflect the received light. The incident surface is disposed on the second end of the substrate and is surrounded by the second reflective surface. The incident surface intersects the second reflective surface at a first intersection line. At least one first distance is defined between the first intersection line and a periphery of the second reflective surface along a first direction. At least one second distance is defined between the first intersection line and the periphery of the second reflective surface along a second direction. Each of the at least one first distance is less than a corresponding one of the at least one second distance. The exit surface is disposed on the first end of the substrate and surrounds the first reflective surface. The exit surface intersects the first reflective surface at a second intersection line. At least one third distance is defined between the second intersection line and a periphery of the exit surface along the first direction. At least one fourth distance is defined between the second intersection line and the periphery of the exit surface along the second direction. Each of the at least one third distance is less than a corresponding one of the at least one fourth distance. An end of a rounded side surface is connected to the second reflective surface and the other end of the rounded side surface is connected to the exit surface. The incident surface is configured to receive the light from an image of a microdisplay. The light enters the substrate through the non-planar incidence surface, is reflected by the first reflective surface and further reflected by the second reflective surface, and exits the substrate through the non-planar exit surface.

In a second aspect, a near-to-eye display device is provided by some embodiments of the present disclosure. The near-to-eye display device includes a microdisplay and the optical module mentioned above. The microdisplay is disposed in the incident surface.

In a third aspect, an optical substrate is further provided by some embodiments of the present disclosure. The optical substrate includes a first optical surface and a second optical surface. The first optical surface includes a first center portion and a first peripheral portion. The first center portion is coated with a reflective film. The first peripheral portion surrounds the first center portion and is free of a reflective film, i.e., is not coated with a reflective film. The second optical surface is disposed in opposite to the first optical surface. The first optical surface and the second optical surface are located on a same optical axis. The second optical surface includes a second center portion and a second peripheral portion. The second center portion is free of a reflective film, i.e., is not coated with a reflective film. The second peripheral portion surrounds the second center portion and is coated with a reflective film. The optical substrate is configured to received light from an image through the second center portion. The light is reflected by the first center portion and is further reflected by the second peripheral portion, and exits the optical substrate through the first peripheral portion.

### BRIEF DESCRIPTION OF THE DRAWINGS

In order to illustrate the technical solutions in the embodiments of the present disclosure more clearly, the following is a brief introduction of the drawings associated with the description of the embodiments. It is obvious that the drawings described as follows are only for some of the embodiments of the present disclosure. For a person of ordinary skills in the art, other drawings may be obtained based on the following drawings without creative work.

FIG. 1 is a schematic view of an optical module according to an embodiment of the present disclosure.

FIG. 2 is a schematic view of an optical module according to another embodiment of the present disclosure.

FIG. 3 is a schematic view of a contour of each surface of an optical module according to an embodiment of the present disclosure.

FIG. 4 is a schematic perspective structural view of an optical module according to an embodiment of the present disclosure.

FIG. 5 is a schematic perspective structural view of an optical module according to still another embodiment of the present disclosure.

FIG. 6 is a schematic perspective structural view of an optical module according to still another embodiment of the present disclosure.

FIG. 7 is a plan view of an optical module according to an embodiment of the present disclosure.

FIG. 8 is a plan view of the optical module in FIG. 7 from an opposite side.

FIG. 9 is a plan view of an optical module according to still another embodiment of the present disclosure.

FIG. 10 is a schematic view of an optical module with an optical path according to an embodiment of the present disclosure.

FIG. 11 is a schematic view of an optical module according to still another embodiment of the present disclosure.

FIG. 12 is a schematic view of an optical module with an optical path according to still another embodiment of the present disclosure.

FIG. 13 is a schematic view of an optical module according to another embodiment of the present disclosure.

FIG. 14 is a schematic perspective structural view of an optical module according to still another embodiment of the present disclosure.

FIG. 15 is a schematic view of an optical module according to another embodiment of the present disclosure.

FIG. 16 is a schematic view of an optical module under an application scenario with an eyeball according to an embodiment of the present disclosure.

FIG. 17 is a flowchart of a processing method for the optical module according to an embodiment of the present disclosure.

### DETAILED DESCRIPTION

The technical solutions in the embodiments of the present disclosure are clearly and thoroughly described below in conjunction with the drawings in the embodiments of the present disclosure. Obviously, the embodiments described are merely a part of the embodiments, rather than all the embodiments, of the present disclosure. Based on the embodiments of the present disclosure, all other embodiments obtained by a person of ordinary skills in the art without creative work fall within the scope of protection of the present disclosure.

In the description of the present disclosure, it is to be understood that, a directional or positional relationship indicated by terms such as “center”, “longitudinal”, “transverse”, “length”, “width”, “thickness”, “above”, “below”, “front”, “back”, “left”, “right”, “vertical”, “horizontal”, “top”, “bottom”, “inside”, “outside”, and etc., is based on a directional or positional relationship illustrated in the drawings and is only used to facilitate and simplify the description of the present disclosure, rather than indicating or implying that the indicated apparatus or component must have a certain direction or must be constructed or operated in the certain direction, thus may not be understood as limitations on the present disclosure. In addition, terms such as “first” and “second” are used for descriptive purposes only and may not be understood to indicate or imply relative importance or implicitly specify the number of indicated technical features. Therefore, a feature defined with the terms “first” and “second” may explicitly or implicitly indicate that one or more feature is included. In the description of the present disclosure, “plurality” means two or more, unless otherwise explicitly and specifically indicated.

In some embodiments of the present disclosure, a term “exemplary” refers to “used as an example, illustration, or description”. Any embodiment described as “exemplary” in the present disclosure is not necessarily to be explained as a preferred or advantageous embodiment over other embodiments. The following description is provided to allow any person of ordinary skills in the art to implement and apply the embodiments of the present disclosure. In the following description, details are set forth for purposes of explanation. It is to be understood that, any person of ordinary skills in the art can recognize that the embodiments of the present disclosure can be realized without the particular details. In other embodiments of the present disclosure, the publicly known structures and processes may not be elaborated in details to avoid making the description of the present disclosure obscure with unnecessary details. Therefore, the present disclosure is not intended to be limited to the embodiments mentioned, but is consistent with the broadest scope of the principles and features disclosed herein.

An optical module 100 is provided by some embodiments of the present disclosure and is explained in details below.

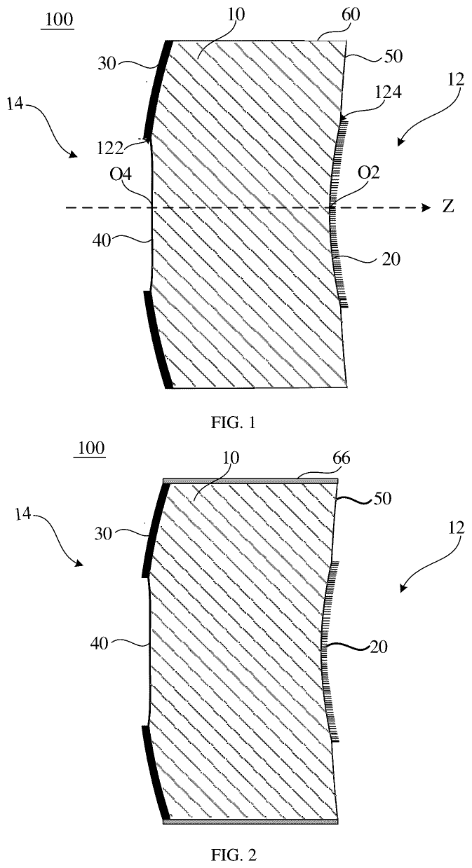

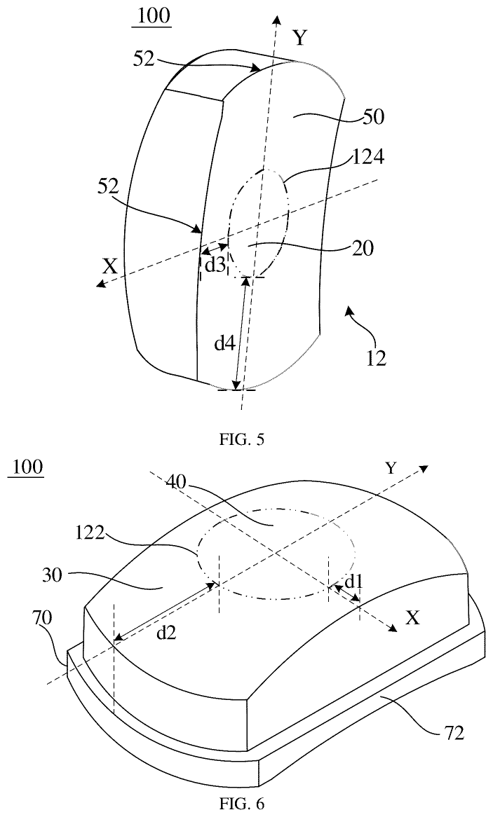

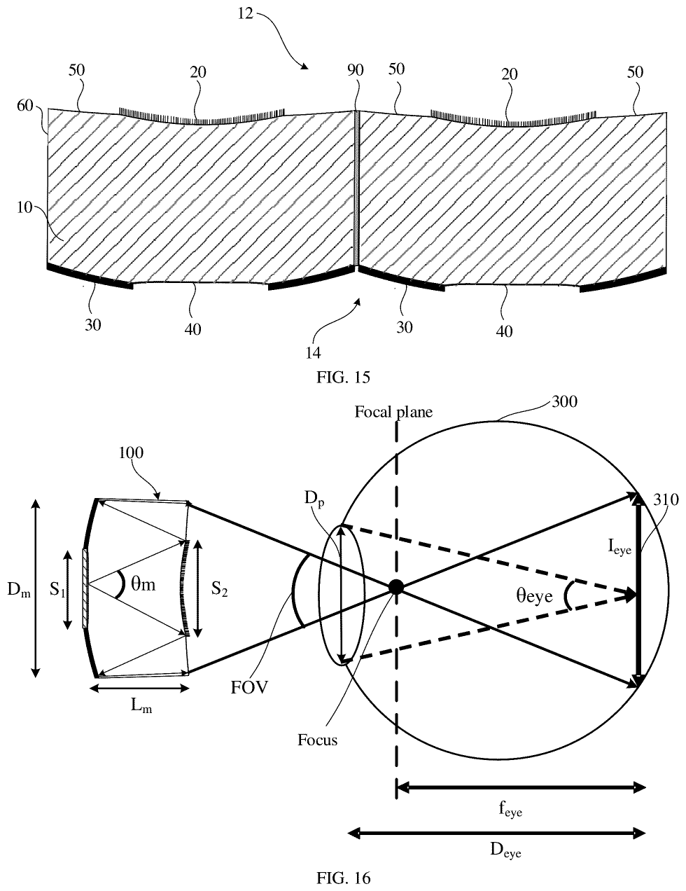

The optical module 100 may be applied to a near-to-eye display device 200, for example, to a near-to-eye display device of Augmented Reality (AR), Virtual Reality (VR), Mixed Reality (MR), Extended Reality (XR), safety glasses, smart glasses, nearsighted glasses, farsighted glasses, sports glasses, a contact lens, a helmet, and other relevant near-to-eye display devices. As illustrated in FIG. 1 to FIG. 16, the optical module 100 includes a substrate or optical substrate 10. The substrate 10 further includes a first end or first optical surface 12 and a second end or second optical surface 14 that is disposed in opposite to the first end 12. In some embodiments, the first end 12 and the second end 14 are located on a same optical axis Z. The substrate 10 may be solid, for example, the substrate 10 may be made of a transparent or light-transparent, hard, and cuttable material, e.g., polymethyl methacrylate (PMMA), polycarbonate (PC), plastic, resin, glass, and etc. The substrate 10 may be cylindrical, prismatic, rounded, or of other regular shape. In some embodiments, the substrate 10 may have a non-regular shape. In some embodiments, the substrate 10 may be hollow. For example, the substrate 10 may include at least two sets of thin walls bonded together using an optical glue, and a center of the substrate 10 may be hollow. A first reflective surface or first center portion 20, a second reflective surface or second peripheral portion 30, an incident surface or second center portion 40, an exit surface or first peripheral portion 50, and etc., may be formed on the thin walls.

The first reflective surface 20 is disposed on the first end 12 of the substrate 10 and is configured to reflect light.

The second reflective surface 30 is disposed on the second end 14 of the substrate 10 and is configured to receive the light reflected by the first reflective surface 20 and reflect the received light. It is to be understood that, the first end 12 is an end of the substrate 10 and the second end 14 is the other end of the substrate 10 that is opposite to the first end 12. A reflective material may be disposed on each of the first reflective surface 20 and the second reflective surface 30. The reflective material may include a metal or a metal alloy, e.g., an aluminum, a silver, a mixture of an aluminum and a silver, and etc.

The incident surface 40 is disposed on the second end 14 of the substrate 10 and is surrounded by the second reflective surface 30. The incident surface 40 intersects the second reflective surface 30 at a first intersection line 122. At least one first distance d1 is defined between the first intersection line 122 and a periphery of the second reflective surface 30 along a first direction X. At least one second distance d2 is defined between the first intersection line 122 and the periphery of the second reflective surface 30 along a second direction Y. Each of the at least one first distance d1 is less than a corresponding one of the at least one second distance d2. It is to be understood that, the at least one first distance d1 may include the shortest distance, the longest distance, or any distance between the shortest distance and the longest distance along the first direction X. The at least one second distance d2 may include the shortest distance, the longest distance, or any distance between the shortest distance and the longest distance along the second direction Y. One or more distance may be denoted by the first distance d1 and only one of the at least one first distance d1 is used here as an example. One or more distance may be denoted by the second distance d2 and only one of the at least one second distance d2 is used here as an example. In case of comparing the at least one first distance d1 and the at least one second distance d2, a comparison may be made between the greatest one of the at least one first distance d1 and the greatest one of the at least one second distance d2, or may be made between the least one of the at least one first distance d1 and the least one of the at least one second distance d2. In some embodiments, the one of the at least one first distance d1 used for the comparison may be determined based on an intended first direction X and the one of the at least one second distance d2 used for the comparison may be determined based on an intended second direction Y. That is, the one of the at least one first distance d1 may be determined by a distance along an axis of the first direction X, i.e., along a line that passes through a center of the first intersection line 122 in the first direction X, and the one of the at least one second distance d2 may be determined by a distance along an axis of the second direction Y, i.e., along a line that passes through the center of the first intersection line 122 in the second direction Y.

The exit surface 50 is disposed on the first end 12 of the substrate 10 and surrounds the first reflective surface 20. The exit surface 50 intersects the first reflective surface 20 at a second intersection line 124. At least one third distance d3 is defined between the second intersection line 124 and a periphery of the exit surface 50 along the first direction X. At least one fourth distance d4 is defined between the second intersection line 124 and the periphery of the exit surface 50 along the second direction Y. Each of the at least one third distance d3 is less than a corresponding one of the at least one fourth distance d4. It is to be understood that, the at least one third distance d3 may include the shortest distance, the longest distance, or any distance between the shortest distance and the longest distance along the first direction X. The at least one fourth distance d4 may include the shortest distance, the longest distance, or any distance between the shortest distance and the longest distance along the second direction Y. One or more distance may be denoted by the third distance d3 and only one of the at least one third distance d3 is used here as an example. One or more distance may be denoted by the fourth distance d4 and only one of the at least one distance d4 is used here as an example. In case of comparing the at least one third distance d3 and the at least one fourth distance d4, a comparison may be made between the greatest one of the at least one third distance d3 and the greatest one of the at least one fourth distance d4, or may be made between the least one of the at least one third distance d3 and the least one of the at least one fourth distance d4. In some embodiments, the one of the at least one third distance d3 used for the comparison may be determined based on an intended first direction X and the one of the at least one fourth distance d4 used for the comparison may be determined based on an intended second direction Y. That is, the one of the at least one third distance d3 may be determined by a distance along the axis of the first direction X and the one of the at least one fourth distance d4 may be determined by a distance along the axis of the second direction Y.

In some embodiments, the first direction X and the second direction Y may be arranged with respect to each other at a predetermined included angle. For example, the included angle between the first direction X and the second direction Y may be approximately 30°, approximately 45°, approximately 60°, approximately 90°, and so on. In some embodiments, the first direction X is configured to correspond to an up-and-down vertical (or perpendicular) orientation of a human eye, and the second direction Y is configured to correspond to a left-and-right lateral (or horizontal) orientation of the human eye. It is to be understood that, in case of the optical module 100 being applied to a head-mounted device, such as glasses, the first direction X may correspond to an up-and-down vertical (or perpendicular) direction of the human eye, for example, the first direction X is parallel or approximately parallel to the up-and-down vertical (or perpendicular) direction of the human eye. The second direction Y may correspond to a left-and-right lateral (or horizontal) direction of the human eye, for example, the second direction Y is parallel or approximately parallel to the left- and -right lateral (or horizontal) direction of the human eye.

The exit surface 50 is disposed on the first end 12 of the substrate 10 and surrounds the first reflective surface 20. An area of the exit surface 50 may be substantially equal to an area of the second reflective surface 30. In some embodiments, the area of the exit surface 50 may be different from the area of the second reflective surface 30.

An end of a rounded or arcuate side surface 60 is connected to the second reflective surface 30 and the other end of the rounded side surface 60 is connected to the exit surface 50. Each of the incident surface 40 and the exit surface 50 may be a plane surface, an aspherical surface, a spherical surface, a free-form surface, or a combination thereof. The incident surface 40 is configured to receive light L from an image of a microdisplay 80. The light L enters the substrate 10 through the incident surface 40, is reflected by the first reflective surface 20 and further reflected by the second reflective surface 30, and leaves or exits the substrate 10 through the exit surface 50.

The microdisplay 80 may, for example, be a Micro Light-Emitting Diode (Micro-LED), a micro light-emitting diode (uLED), a Micro Organic Light-Emitting Diode (Micro-OLED), a Liquid Crystal On Silicon (LCoS), a Liquid Crystal Display (LCD), a Digital Micromirror Device (DMD)/a Digital Light Processing (DLP), a Laser Beam Scanning (LBS), etc., or any combination thereof. In some embodiments, the optical module may be combined with existing ordinary glasses, such as nearsighted glasses, farsighted glasses, safety glasses, sports glasses, and so on, to achieve an AR functionality, thereby allowing the ordinary glasses to be equipped with an AR feature of the smart glasses. It is to be understood that, a black or shaded area of each reflective surface (e.g., the first reflective surface 20 and the second reflective surface 30) in the drawings (e.g., FIG. 1, FIG. 2, FIG. 8-FIG. 11, and etc.) of some embodiments of the present disclosure is merely used to illustrate a presence of a reflective layer and may not represent a thickness of an actual design.

In some embodiments, each of the at least one first distance d1 and each of the at least one second distance d2 may be defined as a certain distance between the first intersection line 122 and the periphery of the second reflective surface 30. In some embodiments, each of the at least one third distance d3 and each of the at least one fourth distance d4 may be defined as a certain distance between the second intersection line 124 and the periphery of the exit surface 50. In some embodiments, each of the at least one first distance d1 and each of the at least one second distance d2 may be defined as a certain distance between the first intersection line 122 and any of a vertical plane, a tangent line, a tangent plane, and etc. In some embodiments, each of the at least one third distance d3 and each of the at least one fourth distance d4 may be defined as a certain distance between the second intersection line 124 and any of a vertical plane, a tangent line, a tangent plane, and etc. Each of the at least one first distance d1 may refer to a length of a corresponding one of two or more line segments defined between the first intersection line 122 and the periphery of the second reflective surface 30 along the first direction X. In some embodiments, the corresponding one of two or more line segments defined between the first intersection line 122 and the periphery of the second reflective surface 30 along the first direction X may be located on one of two or more sides of the incident surface 40. Each of the at least one second distance d2 may refer to a length of a corresponding one of two or more line segments defined between the first intersection line 122 and the periphery of the second reflective surface 30 along the second direction Y. In some embodiments, the corresponding one of two or more line segments defined between the first intersection line 122 and the periphery of the second reflective surface 30 along the second direction Y may be located on one of two or more sides of the incident surface 40. Each of the at least one third distance d3 may refer to a length of a corresponding one of two or more line segments defined between the second intersection line 124 and the periphery of the exit surface 50 along the first direction X. In some embodiments, the corresponding one of two or more line segments defined between the second intersection line 124 and the periphery of the exit surface 50 along the first direction X may be located on one of two or more sides of the first reflective surface 20. Each of the at least one fourth distance d4 may refer to a length of a corresponding one of two or more line segments defined between the second intersection line 124 and the periphery of the exit surface 50 along the second direction Y. In some embodiments, the corresponding one of two or more line segments defined between the second intersection line 124 and the periphery of the exit surface 50 along the second direction Y may be located on one of two or more sides of the first reflective surface 20. Taking the first direction X being perpendicular to the second direction Y as an example, an extension direction of one of two or more line segments, a length of which defines a corresponding one of the at least one first distance d1, may be perpendicular to an extension direction of one of two or more line segments, a length of which defines a corresponding one of the at least one second distance d2; an extension direction of one of two or more line segments, a length of which defines a corresponding one of the at least one third distance d3, may be perpendicular to an extension direction of one of two or more line segments, a length of which defines a corresponding one of the at least one fourth distance d4.

In some embodiments, each of the at least one first distance d1 and each of the at least one third distance d3 may be set to be sufficiently small or even zero. In some embodiments, each of the at least one second distance d2 and each of the at least one fourth distance d4 may be non-zero.

In the related art, in order to reduce a probability of eccentricity in the optical module, the substrate 10 and the surfaces of the substrate 10 generally share a uniform circumferential dimension. For example, in some embodiments, the substrate 10 is cylindrical. In this case, the exit surface 50 and the second reflective surface 30 share a same width in a circumferential direction, and the incident surface 40 is generally a plane surface to ensure an entirety of the whole module during a subsequent packaging (e.g., an entirety of a regular cylinder, and etc.). However, in an actual application scenario, the human eye is a three-dimensional optical system with a field of view in the left-and-right horizontal direction and a field of view in the up-and-down vertical direction. Generally speaking, the field of view of the human eye in the left-and-right (or horizontal) direction is wider than the field of view of the human eye in the up-and-down (or vertical) direction. Therefore, the optical module in some embodiments of the present disclosure is configured to have different distances (or lengths) along the first direction X and the second direction Y. That is, the first direction X of the optical module corresponds to a vertical field of view of the human eye and the second direction Y of the optical module corresponds to a horizontal field of view of the human eye. Each of the at least one first distance d1 and each of the at least one third distance d3 along the first direction X is shorter than each of the at least one second distance d2 and each of the at least one fourth distance d4 along the second direction Y. In this way, the field of view in the first direction X is narrower than the field of view along the second direction Y, which corresponds to or matches with the field of view of the human eye in the vertical direction being narrower than the field of view of the human eye in the horizontal direction, thereby effectively reducing a fatigue of a user's eyeballs caused by the user adapting to the field of view during an extended use and enhancing the user's viewing experience.

In some embodiments, the exit surface 50 is set to be a plane surface. However, research in the present disclosure has found that, due to a dimensional requirement in product design, such as miniaturization, lightweight construction, and integration with the existing glasses, an area of each of the incident surface, the first reflective surface, the second reflective surface, the exit surface, and etc., may not increase arbitrarily. In other words, the optical module is limited to a small dimension within a fixed range, for example, less than 5 mm*5 mm*5 mm or even smaller. Some embodiments of the present disclosure change each of the incident surface and the exit surface from the plane surface to a non-planar surface. The non-planar surface may be, for example, an aspherical surface, a spherical surface, a free-form surface, or a combination thereof. The shape of each surface is fully redesigned so that the image light L from the microdisplay 80 enters the substrate 10 through the non-planar incident surface 40. The incident surface 40 may be one or a combination of an aspherical surface, a spherical surface, and a free-form surface. After the image light L enters the substrate 10, the image light L then reaches the first reflective surface 20 and is reflected by the first reflective surface 20 to the second reflective surface 30. Finally, the image light L leaves or exits the substrate 10 through the non-planar exit surface 50. The exit surface 50 may be one or a combination of an aspherical surface, a spherical surface, and a free-form surface. The light L from an edge or a near-edge position of the microdisplay 80 (as illustrated in FIG. 8) tends to converge toward the optical axis. In contrast, in case of each of the incident surface and the exit surface being a plane surface in the related art, the light L from the edge or the near-edge position of the microdisplay 80 may not converge toward the optical axis. Therefore, setting each of the exit surface and the incident surface to be a non-planar surface may effectively improve a utilization of the light from the edge or the near-edge position of the microdisplay 80, reduce a light loss, and enhance a light efficiency. In addition, the light in the related art may not tend to converge toward the optical axis, which results in a narrower field of view. However, some embodiments of the present disclosure effectively utilize the light L from both a center and the edge of the microdisplay 80 to greatly enhance the field of view. Moreover, a folded optical path effectively reduces an overall dimension of the optical system, such that a shorter reflective path may reduce the light loss and enhance the light efficiency, thereby leading to a better overall image quality.

In some embodiments, as illustrated in FIG. 4 to FIG. 9, the first direction X is perpendicular to the second direction Y, each of the at least one fourth distance d4 is less than or equal to a corresponding one of the at least one second distance d2 and each of the at least one third distance d3 is less than or equal to a corresponding one of the at least one first distance d1. It is to be understood that, the rounded side surface 60 tends to gradually become smaller along a direction from the second reflective surface 30 to the exit surface 50. That is, an outer diameter of the exit surface 50 may be smaller than an outer diameter of the second reflective surface 30. It is further to be understood that, a cross section of the rounded side surface 60 tends to decrease along a line connecting from the second reflective surface 30 to the exit surface 50, which ensures the light L that comes from the microdisplay 80 and enters the substrate 10 through the edge of the incident surface 40 to effectively converge to a position close to the central optical axis Z, thereby further enhancing the field of view, improving the light efficiency, and realizing a better image quality.

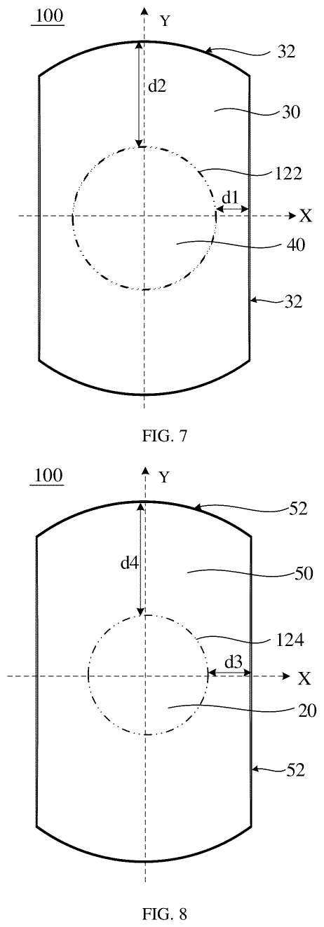

In some embodiments, as further illustrated in FIG. 4 to FIG. 9, a length of one of two or more line segments defined between the first intersection line 122 and the periphery of the second reflective surface 30 varies periodically, within a range between a corresponding one of the at least one first distance d1 and a corresponding one of the at least one second distance d2, along a clockwise direction with respect to a circumference of the first intersection line 122. A length of one of two or more line segments defined between the second intersection line 124 and the periphery of the exit surface 50 varies periodically, within a range between a corresponding one of the at least one third distance d3 and a corresponding one of the at least one fourth distance d4, along a clockwise direction with respect to a circumference of the second intersection line 124. It is to be understood that, taking FIG. 7 as an example, the first direction X intersects the second direction Y at an origin, i.e., the origin is the center of the first intersection line 122. Taking the origin as a center and rotating a point about the origin along the first intersection line 122 from a starting position at which a line segment between the periphery of the second reflective surface 30 and the starting position defines a first distance d1 in a positive direction along the axis of the first direction X. Along the clock direction, a length of the line segment defined between the rotating point and the periphery of the second reflective surface 30 increases to a second distance d2 (in a negative direction along the axis of the second direction Y), decreases back to the first distance d1 (in a negative direction along the axis of the first direction X), gradually increases to the second distance d2 (in a positive direction along the axis of the second direction Y), and finally decreases back to the first distance d1 at the starting position in the positive direction along the axis of the first direction X. The length of one of two or more line segments defined between the second intersection line 124 and the periphery of the exit surface 50 varies periodically following the same pattern above and will not further explained herein. Overall, an area of a region containing one of the at least one second distance d2 may generally be greater than an area of a region containing a corresponding one of the at least one first distance d1, which ensures that the field of view of the optical module in the second direction Y is greater than the field of view of the optical module in the first direction X.

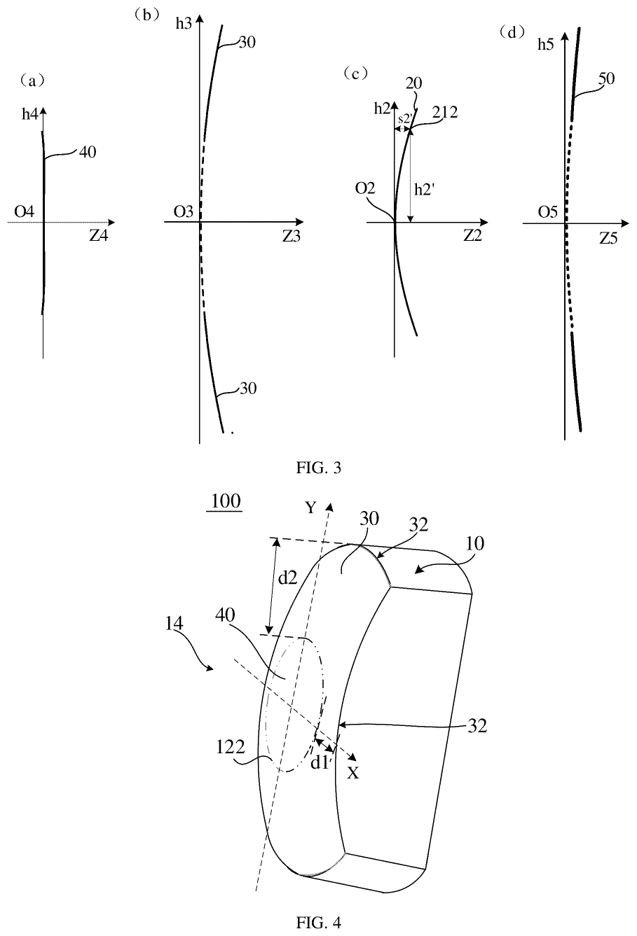

In some embodiments, as illustrated in FIG. 3, each of the first reflective surface 20 and the second reflective surface 30 is one or a combination of an aspherical total internal reflection surface, a spherical total internal reflection surface, and a free-form total internal reflection surface. It is to be understood that, a total internal reflection may effectively reduce the optical loss and improve the light efficiency and image quality. In some embodiments, the incident surface 40 includes a first section and a second section from the center to the periphery thereof. The first section is curved or bent in a first direction toward the optical axis Z and the first direction may be a positive direction of the optical axis Z (an exiting direction of light). The second section is curved or bent in a second direction opposite to the first direction along the optical axis Z and the second direction may be a negative direction of the optical axis Z (a direction away from the exiting direction of the light). Each of the first reflective surface 20, the second reflective surface 30, and the exit surface 50 is curved or bent in the first direction toward the optical axis Z, i.e., is curved in the positive direction toward the optical axis Z. It is to be understood that, the first section of the incident surface 40 corresponds to the center or a near-center region of the microdisplay 80, and the second section of the incident surface 40 corresponds to the edge or the near-edge region (relatively far from the center) of the microdisplay 80. Therefore, the light from the edge or the near-edge of the microdisplay 80 may be reflected as much as possible to an edge or a near-edge of the first reflective surface 20, then may be further reflected by the first reflective surface 20 to an edge or a near-edge of the second reflective surface 30, and finally may be directed by the non-planar exit surface 50 toward the center of the optical axis Z, which effectively improves the utilization of light from the edge or the near-edge of the microdisplay 80 and enhances the light efficiency and the image quality. Each of the first reflective surface 20, the second reflective surface 30, the exit surface 50, and the incident surface 40 may be set to be a non-planar surface, for example, an aspherical surface, a spherical surface, a free-form surface, or a combination thereof. However, each of the first reflective surface 20, the second reflective surface 30, the exit surface 50, and the incident surface 40 may be curved or bent in a different direction. In some embodiments, each of the first reflective surface 20, the second reflective surface 30, and the exit surface 50 may be curved in a same direction. In some embodiment, each of the incident surface 40, the first reflective surface 20, the second reflective surface 30, and the exit surface 50 is curved in the first direction toward the optical axis Z, i.e., curved in the positive direction toward the optical axis Z. As illustrated in Table 1, a sag value or sagittal value or height value of a vector of each of the incident surface 40, the first reflective surface 20, the second reflective surface 30, and the exit surface 50 is positive. A coordinated design of the surfaces may fold the optical path, thereby effectively increasing the field of view of the emitted light, enhancing the light efficiency, and improving the image quality.

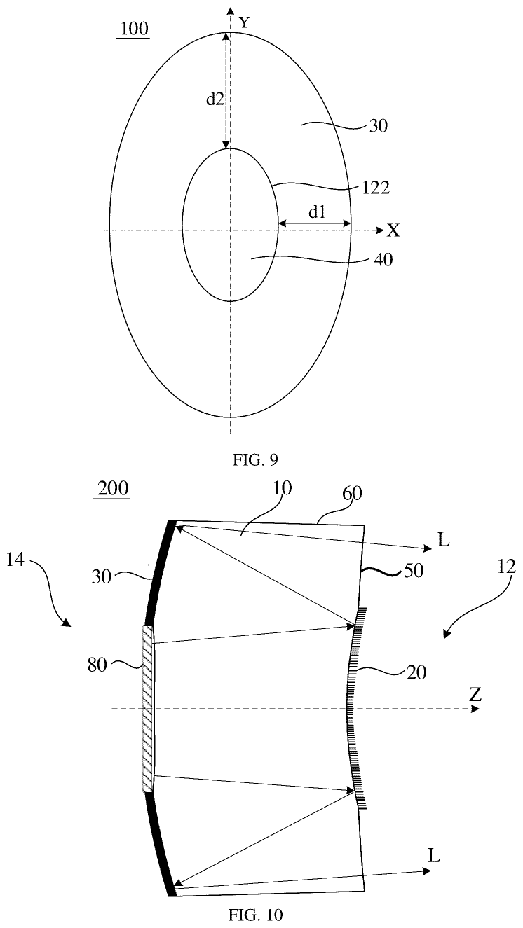

In some embodiments, a contour shape of each of the second reflective surface 30, the exit surface 50, the incident surface 40, and the first reflective surface 20 may be projected on a plane perpendicular to the optical axis Z. The contour shape may be circular, elliptical, polygonal, rounded rectangular, trapezoidal, and other geometric shapes. The plane perpendicular to the optical axis Z may be a cross section, may be a view from the first end 12 or the second end 14, or may be a plane where a corresponding top or bottom view is located. As illustrated in FIG. 4 to FIG. 8, the contour shape of the incident surface 40 may be similar to the contour shape of the first reflective surface 20, and the contour shape of the second reflective surface 30 may be similar to the contour shape of the exit surface 50. In some embodiments, as illustrated in FIG. 9, the contour shape of the incident surface 40 may be similar to the contour shape of the second reflective surface 30, and the contour shape of the exit surface 50 may be similar to the contour shape of the first reflective surface 20. It is to be understood that, a geometric shape of the outer contour of each of the surfaces of the substrate 10 may be flexibly designed according to an outer counter of the microdisplay 80 or an overall outer contour to meet an assembly need for different sizes and shapes and to fully capture the light from the microdisplay 80. In some embodiments, each of the second reflective surface 30, the exit surface 50, the incident surface 40, and the first reflective surface 20 may share a same contour, e.g., one of a circle, an ellipse, or a regular polygon, to ensure that the light from the microdisplay 80 may be fully reflected and utilized, thereby achieving a better image quality and light efficiency.

In some embodiments, as illustrated in FIG. 1 and FIG. 3, the first reflective surface 20 includes a first vertex O2, the second reflective surface 30 includes a second vertex O3, the incident surface 40 includes a third vertex O4, and the exit surface 50 includes a fourth vertex O5. The first vertex O2, the second vertex O3, the third vertex O4, and the fourth vertex O5 are all located on the optical axis Z. The incident surface 40, the first reflective surface 20, the second reflective surface 30, and the exit surface 50 are symmetrically designed with respect to a cross section where the optical axis is located to ensure that the optical module 100 is not eccentric, i.e., to ensure that an optical path area of one side is not greatly larger or smaller than an optical path area of the other side. It is to be understood that, the second vertex O3 may be a point where a curved surface of the second reflective surface 30 extends toward and intersects the center of the incident surface 40. A dashed line in FIG. 3(b) indicates the curved surface of the second reflective surface 30 extending toward and intersecting the center of the incident surface 40 at the second vertex O3. Similarly, the fourth vertex O5 may be a point where the curved surface of the exit surface 50 extends toward and intersects the center of the first reflective surface 20. A dashed line in FIG. 3(d) indicates the curved surface of the exit surface 50 extending toward and intersecting the center of the first reflective surface 20 at the fourth vertex O5. It is to be understood that, the vertices of the second reflective surface 30, the exit surface 50, the incident surface 40, and the first reflective surface 20 are all located on the same optical axis Z to ensure an overall symmetry of the optical path. The second reflective surface 30, the exit surface 50, the incident surface 40, and the first reflective surface 20 may be designed symmetrically with respect to or about the optical axis Z, or the aforementioned surfaces may be designed symmetrically with respect to or about a plane passing through the optical axis Z. A coaxial design of the second reflective surface 30, the exit surface 50, the incident surface 40, and the first reflective surface 20 ensures that the entire optical path is not eccentric (i.e., deviating from the optical axis Z or resulting in an excessive distortion in a final image, etc.), thereby realizing a clearer image and a higher image quality.

In some embodiments, as illustrated in FIG. 1 and FIG. 4 to FIG. 8, the incident surface 40 intersects the second reflective surface 30 at the first intersection line 122, and the exit surface 50 intersects the first reflective surface 20 at the second intersection line 124. Each of the first intersection line 122 and the second intersection line 124 may be understood as an intersection of different surfaces, which is denoted by dashed lines in the drawings for ease of understanding. A shape of the intersection line may be determined by an outer contour shape of the incident surface 40 or an outer contour shape of the first reflective surface 20. In some embodiments, the shape of the intersection line may be determined by an inner contour shape of the second reflective surface 30 or an inner contour shape of the exit surface 50. For example, each of the first intersection line 122, the second intersection line 124, the incident surface 40, and the first reflective surface 20 may be in shape of a circle, an ellipse, a polygon, and so forth. In some embodiments, a distance between the first vertex O2 and the third vertex O4, i.e., a center thickness of the optical module 100, is not greater than (i.e., less than or equal to) 2.8 mm. For example, the center thickness of the optical module 100 along the optical axis Z is not greater than 2.8 mm, which may, for example, be 2.8 mm, 2.5 mm, 2 mm, 1.8 mm, 1.6 mm, and etc. In some embodiments, the center thickness of the optical module 100 may be understood to be an average thickness between the exit surface 50 and the incident surface 40, or may be understood to be an average thickness of the entire substrate 10, etc. A distance between the first intersection line 122 and a line connecting the second vertex O3 and the third vertex O4 is not greater than 1.35 mm. That is, a radius of the incident surface 40 is not greater than 1.35 mm, which may be, for example, 1.35 mm, 1.2 mm, 1 mm, 0.8 mm, 0.6 mm, and etc. The distance between the second intersection line 124 and a line connecting the first vertex O2 and the fourth vertex O5 is not greater than 1.5 mm. That is, a radius of the first reflective surface 20 is not greater than 1.5 mm, which may be, for example, 1.5 mm, 1.3 mm, 1 mm, 0.85 mm, 0.75 mm, and etc. In some embodiments, a corresponding radius (a vertical distance from an outer contour to a vertex) of each of the rounded side surface 60, the exit surface 50, and the second reflective surface 30 may be not greater than 3 mm. That is, a radius of the rounded side surface 60 is not greater than 3 mm, a radius of the exit surface 50 is not greater than 3 mm, and a radius of the second reflective surface 30 is not greater than 3 mm, which may be, for example, 3 mm, 2.8 mm, 2.5 mm, 2 mm and etc. A distance between the second intersection line 124 and the periphery of the exit surface 50 is greater than 0 and less than or equal to 1.6 mm, which may be, for example, 1 mm, 1.5 mm, 0.8 mm, 0.7 mm, and etc. It is to be understood that, parameters mentioned above may not lead to contradictions in case of being combined with each other, the radius mentioned above may be a radius parameter in case of the projected shape of each surface on a plane being a circle, and etc. In some embodiments, in case of the projected shape of each of the surfaces above on a plane not being a circle, for example, instead being a square polygon, an ellipse, or other regular shape, the above radius may be understood as a maximum radius thereof. Taking an ellipse as example, a long side of the ellipse may be explained as the radius mentioned above. A dimensional design provided by some embodiments of the present disclosure may allow the entire optical module to have a smaller volume and a lighter weight without affecting an optical transmission efficiency, which facilitates adapting the optical module for a frame or a lens of the existing near-to-eye display device (e.g., nearsighted glasses, farsighted glasses, safety glasses, sports glasses, smart glasses, and helmets). In addition, without changing a structural design of the existing display device to a great extent, a compatibility between the AR and a traditional display device may be realized, thereby enhancing the application scenario of the optical module.

In some embodiments, as illustrated in FIG. 16, the light from the microdisplay passes through the optical module, reaches a pupil of an eyeball 300, and forms an image 310 on a retina. A positional relationship between relevant components (e.g., the eyeball 300, the image 310, and etc.) in FIG. 16 is only provided as an exemplary descriptive illustration to facilitate computation and understanding. The following computation may be performed in one dimension, and certain computations, e.g., a small angle approximation, may be performed to illustrate various principles. The small angle approximation may be: θ≈sin θ≈tan θ. The above calculation may be directly extended to two dimensions and may be performed in a more accurate way. The field of view (FOV) may finally be imaged by the optical module on the retina. From the retina end, according to a calculation formula of the optical extension E_{eye}:

$${E}_{e y e} = \int {\int }_{θ , I} {n}_{e y e}^{2} cos θ d θ dI \leq {n}_{e y e}^{2} {I}_{e y e} {θ}_{e y e} = {n}_{e y e}^{2} {I}_{e y e} \frac{min \{ {D}_{p} , {D}_{m} \}}{{D}_{e y e}} = {n}_{e y e}^{2} {FOVf}_{e y e} \frac{min \{ {D}_{p} , {D}_{m} \}}{{D}_{e y e}} \qquad \{ 1 \}$$

In some embodiments, a lower limit of the FOV may be derived from the equation {1} above:

$$F O V \geq ( \int {\int }_{θ , I} cos θ d θ dI ) \frac{{D}_{e y e}}{{f}_{e y e} min \{ {D}_{p} , {D}_{m} \}} , where , \frac{- {θ}_{e y e}}{2} \leq θ \leq \frac{{θ}_{e y e}}{2} , 0 \leq I \leq {I}_{e y e} ; \qquad \{ 2 \}$$

From the optical module end, according to a calculation formula of the optical extension E_{eye}:

$${E}_{e y e} = \int {\int }_{{θ}_{e y e} , I} {n}_{e y e}^{2} cos θ d θ dI \leq {n}_{e y e}^{2} {I}_{e y e} max \{ {θ}_{e y e} \} = {n}_{e y e}^{2} {FOVf}_{e y e} \frac{min \{ {D}_{p} , {D}_{m} \}}{{D}_{e y e}} \leq {E}_{m} = \int {\int }_{{θ}_{m} = 0 , S = 0}^{{θ}_{m} = max \{ {θ}_{m} \} S = {S}_{1}} {n}_{m}^{2} cos θ d θ {dS}_{1} \leq {n}_{m}^{2} {S}_{1} max \{ {θ}_{m} \} = {n}_{m}^{2} {S}_{1} {S}_{2} / {L}_{m} \qquad \{ 3 \}$$

In some embodiments, an upper limit of the FOV may be derived the equation {3} above:

$$F O V \leq \frac{{D}_{e y e} {n}_{m}^{2} {S}_{1} {S}_{2}}{{f}_{e y e} min \{ {D}_{p} , {D}_{m} \} {n}_{e y e}^{2} {L}_{m}} \qquad \{ 4 \}$$

In the equations above, FOV is a field of view, n_{eye} is a refractive index of the eyeball, Dₚ is an aperture diameter of the pupil, θ_{eye} is an angle of incidence on the retina, I_{eye} is a size of the retinal image 310, D_{eye} is a diameter of the eyeball, f_{eye} is a focal length of the eyeball, and Om is an effective exit angle of the microdisplay. Dₘ is a maximum outer diameter of the optical module, i.e., the largest outer diameter of one of the rounded side surface 60, the exit surface 50, and the second reflective surface 30. S₁ is a diameter of the incident surface 40, i.e., twice the distance between the first intersection line 122 and a line connecting the second vertex O3 and the third vertex O4. S₂ is a diameter of the first reflective surface 20, i.e., twice the distance between the second intersection line 124 and a line connecting the first vertex O2 and the fourth vertex O5. Lm may be a thickness of the substrate 10, may be a center thickness of the optical axis or an average thickness of the substrate 10, or may be an average thickness of the optics module from the microdisplay to the first reflective surface 20, and etc.

It is to be understood that, the upper limit of the FOV may generally be determined more upon the parameters of the optical module. In this way, since the dimension of the optical module may in general be restricted strictly (or may be fixed), e.g., with a small size and being adapted for the traditional head-mounted device, the lower limit of the FOV may generally be more important and may be determined based on the actual need of the design. In the formula for calculating the lower limit of the FOV, the first term is a double integral of an angle over a size of the image, which exists in whole as an implicit expression in terms of the design of the optical module. In this way, each of the incident surface 40 and the exit surface 50 may be designed to be a non-planar surface, e.g., one or a combination of an aspherical surface, a spherical surface, and a free-form surface, so that the non-planar surface may increase a value of the double integral, thereby increasing the lower limit (i.e., the minimum value) of the FOV of the optical module.

In some embodiments, each of the at least one first distance d1 along the first direction X that corresponds to the vertical direction of the human eye is less than a corresponding one of the at least one second distance d2 along the second direction Y that corresponds to the horizontal direction of the human eye, and each of the at least one third distance d3 along the first direction X that corresponds to the vertical direction of the human eye is less than a corresponding one of the at least one fourth distance d4 along the second direction Y that corresponds to the horizontal direction of the human eye. In this way, the value of the double integral and a value of the FOV of the entire lower limit formula {2} in the second direction Y may be different from the value of the double integral and a value of the FOV of the entire lower limit formula {2} in the first direction X, respectively. That is, the calculated value corresponding to the FOV of the human eye in the vertical (perpendicular) direction is different from the calculated value corresponding to the FOV of the human eye in the horizontal (lateral) direction. In addition, regarding the upper limit formula {4}, each of the at least one first distance d1 is less than a corresponding one of the at least one second distance d2 and each of the at least one third distance d3 is less than a corresponding one of the at least one fourth distance d4, which further results in the upper limit of the FOV in the second direction Y to be different from the upper limit of the FOV in the first direction X. For example, the value corresponding the second direction Y (horizontal direction) may be greater than the value corresponding the first direction X (vertical direction), thereby allowing the FOV in a different exiting direction of light to be different, e.g., the FOV in the second direction Y is greater than the FOV in the first direction X. In some embodiments, in case of the relevant parameters, e.g., the existing size and the eyeball, being defined, the FOV is relatively difficult to be changed due to the size limitation. Therefore, some embodiments of the present disclosure may change each of the incidence surface 40 and the exit surface 50 from a plane surface to a non-planar surface, thereby allowing the light from the near-edge of the microdisplay to enter the first reflective surface 20 and to be exited the substrate 10 through the exit surface 50. Furthermore, a design of various FOV may be realized through setting a corresponding distance in a different direction, which ensures the optical module to be more aligned with or adapted to or match with the FOV of the human eye. As a result, the light from the edge of the microdisplay is more fully utilized and may be projected in a greater included angle with respect to the optical axis Z, thus forming a wider FOV with a better light effect and a better image quality. In addition, the FOV in the second direction Y is wider than the FOV in the first direction X, which allows the optical module to be located in the FOV of the human eye. In this way, the horizontal FOV of the human eye corresponds to (e.g., parallel or roughly parallel) the FOV of the optical module in the second direction Y and the vertical (up-and-down) FOV of the human eye corresponds to the FOV of the optical module in the first direction X, which ensures a light exiting FOV of the optical module to more match with or aligned with the FOV and an eye movement habit of the human eye, thereby effectively reducing the visual fatigue during use and improving the user's viewing experience.

In some embodiments, a surface, i.e., an aspherical surface, a spherical surface, and a free-form surface, of each of the incident surface 40, the first reflective surface 20, the second reflective surface 30, and the exit surface 50 may be described by a polynomial sag equation, e.g., may be obtained through calculations using Zernike polynomials. The polynomial sag equation may be the following:

$$Z = \frac{c {h}^{2}}{1 + \sqrt{1 - ( 1 + k ) {c}^{2} {h}^{2}}} + A {h}^{4} + B {h}^{6} + C {h}^{8} + D {h}^{10} .$$

Z is a sag of a surface, i.e., a distance between the surface and the vertex (e.g., s2′ in FIG. 3c). h is a radial distance (a distance between the surface and the optical axis, e.g., h2′ in FIG. 3c). c is a curvature of the surface. k is a coefficient. Each of A, B, C, and D is a corresponding multi-order coefficient. In case of k, A, B, C, and D all being zero, the polynomial sag equation may serve as a sag calculation formula for a spherical surface. In case of the surface being a free-form surface, a plurality of reference points may be taken to calculate the formula. A schematic view of a contour of each of the surfaces is illustrated in FIG. 3. FIG. 3(a) is a schematic view of a contour of the incident surface 40. FIG. 3(b) is a schematic view of a contour of the second reflective surface 30. FIG. 3(c) is a schematic view of a contour of the first reflective surface 20. FIG. 3(d) is a schematic view of a contour of the exit surface 50. Taking the schematic view of the contour of the first reflective surface 20 in FIG. 3(c) as an example, the first reflective surface 20 includes a vertex O2 and is curved toward two orthogonal axes (e.g., a h-Z axis). The first reflective surface 20 includes at least one first position 212. The at least one first position 212 is a radial distance h2′ away from the Z-axis (optical axis) that passes through the vertex O2. The at least one first position 212 has a displacement s2′ with respect to the h-axis relative at the vertex O2. The table 1 below exemplarily describes relevant parameters associated with some surfaces. h4 and Z4 are parameters of the incident surface 40, h2 and Z2 are parameters of the first reflective surface 20, h3 and Z3 are parameters of the second reflective surface 30, and h5 and Z5 are parameters of the exit surface 50.

TABLE 1

| h4 | h2 | h3 | h5 | Z4 | Z2 | Z3 | Z5 |
|---|---|---|---|---|---|---|---|
| 0.3 | 0.3 | 0.3 | 0.3 | 0.010149 | 0.012344 | 0.008044 | 0.001135 |
| 0.6 | 0.6 | 0.6 | 0.6 | 0.032673 | 0.048471 | 0.032232 | 0.004796 |
| 0.70 | 0.70 | 0.70 | 0.70 | 0.039537 | 0.065396 | 0.043906 | 0.006695 |
| 0.80 | 0.80 | 0.80 | 0.80 | 0.044606 | 0.084556 | 0.057400 | 0.008994 |
| 0.9 | 0.9 | 1.2 | 1.2 | 0.047149 | 0.105807 | 0.129787 | 0.023188 |
| 1.0 | 1.0 | 1.5 | 1.5 | 0.046729 | 0.128990 | 0.203805 | 0.040762 |
| — | — | 1.8 | 1.8 | — | — | 0.295270 | 0.066395 |
| | | 2.1 | 2.1 | | | 0.404795 | 0.102200 |

In some embodiments, as illustrated in FIG. 6, the optical module further includes an outer flange 70. The outer flange 70 is disposed on the rounded side surface 60 and a height of the outer flange 70 may be greater than a height of the rounded side surface 60. The outer flange 70 may surround and encircle a periphery of the rounded side surface 60, or may be spaced apart from each other along the periphery of the rounded side surface 60. The outer flange 70 may not extend beyond the rounded side surface 60 along the direction of the optical axis Z, i.e., a thickness of the outer flange 70 may not be greater than the height of the rounded side surface 60. Therefore, the outer flange 70 may be a relatively thin protrusion, or may be a thread or other snap-in structure, etc. In some embodiments, the outer flange 70 may be located at an end of the rounded side surface 60 that is close to the exit surface 50. The outer flange 70 is configured to be cooperatively assembled with an external mechanism. The external mechanism may be, for example, a clamp, a fixture, and etc., in order to facilitate clamping or transporting the optical module and to avoid damage to the substrate 10 or other surfaces. In some embodiments, the external mechanism may be a housing in which the optical module needs to be assembled, such as a corresponding assembly housing that includes a fixing slot, and etc., so that the optical module may be positioned or fixed through the outer flange 70.

In some embodiments, as illustrated in FIG. 6, the outer flange 70 further includes at least one straight edge 72. In some embodiments, the outer flange 70 may include at least one arcuate edge and the at least one straight edge 72 may be tangent to the at least one arcuate edge of the outer flange 70. In some embodiments, the outer flange 70 may include two straight edges 72 that are parallel to each other or may include more than two straight edges 72. In case of the outer edge being in shape of a polygon, a straight edge of the polygon may be the straight edge 72 and the straight edge 72 is configured to cooperate with the external mechanism to ensure a positioning of a rotational adjustment to the substrate 10. It is to be understood that, the external mechanism may be, for example, a clamp, fixture, and etc., so that the straight edges that are parallel to each other may better allow the substrate 10 to be positioned or clamped. In some embodiments, the external mechanism may be, for example, an assembly housing. In some embodiments, the optical module may be rotated as a whole within the assembly housing, for example, to adjust the light exiting angle of the optical module, and etc., and the straight edge 72 may be used for fool-proof, positioning, and etc.

In some embodiments, as illustrated in FIG. 2, the optical module may further include a masking or shielding or blocking layer 66. The masking layer 66 covers the rounded side surface 60 and is configured to avoid the light of the microdisplay 80 from transmitting to an exterior of the substrate 10 through the rounded side surface 60. The masking layer 66 may be a coating or a material, such as black epoxy, black silicone rubber, carbon black, nickel black, black chrome, fanta black, or may be a light-proof sealing sleeve, etc. The masking layer 66 is configured to ensure that the light leaves or exits the substrate 10 through the exit surface 50, instead of through the rounded side surface 60, thereby effectively enhancing the optical efficiency.

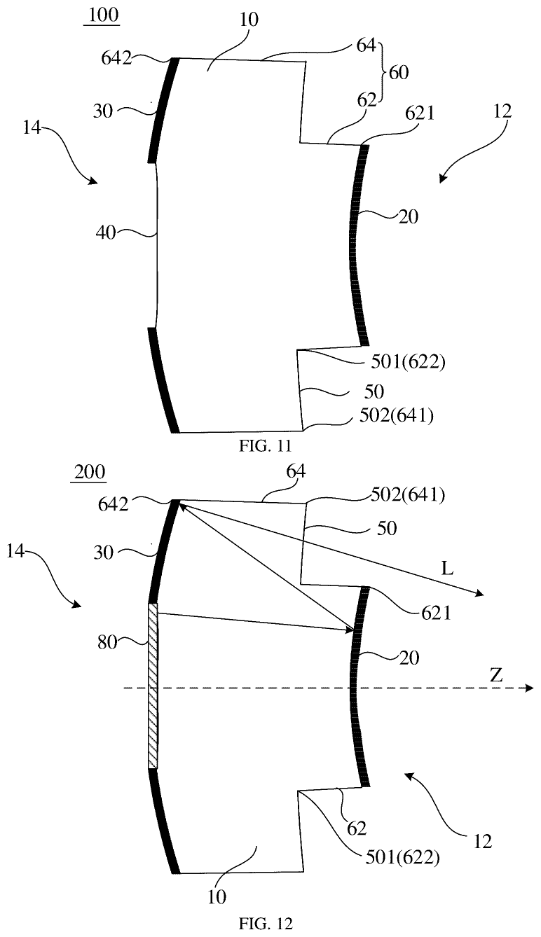

In some embodiments, as illustrated in FIG. 11 and FIG. 12, the rounded side surface 60 further includes a first rounded surface 62 and a second rounded surface 64. A circumference of the first rounded surface 62 is smaller than a circumference of the second rounded surface 64. A first end 621 of the first rounded surface 62 is connected to the first reflective surface 20 and a second end 622 of the first rounded surface 62 is connected to a first end 501 of the exit surface 50. A second end 502 of the exit surface 50 is connected to a first end 641 of the second rounded surface 64. A second end 642 of the second rounded surface 64 is connected to the second reflective surface 30. The first end 621 of the first rounded surface 62 is arranged opposite to the second end 622 of the first rounded surface 62. The first end 641 of the second rounded surface 64 is arranged opposite to the second end 642 of the second rounded surface 64. It is to be understood that, the exit surface 50 is located between the first rounded surface 62 and the second rounded surface 64 that has a size different from the first rounded surface 62. In some embodiments, the first rounded surface 62 and the second rounded surface 64 may tend to gradually become smaller along the positive direction of the optical axis Z, thereby realizing an effective light harvesting. It is to be understood that, the first rounded surface 62 is greatly different from the second rounded surface 64 in terms of a lateral dimension to form a stepped structure, thereby further reducing an overall size and weight.

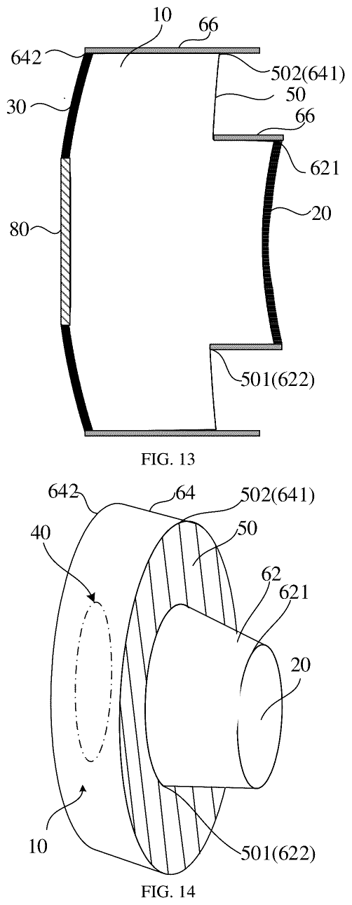

In some embodiments, as illustrated in FIG. 13, the masking layer 66 disposed on the second rounded surface 64 extends from the periphery of the exit surface 50 along a direction away from the exit surface 50. An end surface of the masking layer 66 disposed on the second rounded surface 64 is not higher than an end face of the first reflective surface 20. In other words, a distance between a center of the optical module and a projection of the end surface of the masking layer 66 disposed on the second rounded surface 64 on the optical axis Z is less than or equal to a distance between the center of the optical module and a projection of the end face of the first reflective surface 20 on the optical axis Z. The masking layer 66 disposed on the second rounded surface 64 is long enough to avoid the light from entering the exterior from the edge of the exit surface 50 too early, thereby reducing a formation of stray light.

In some embodiments, as illustrated in FIG. 15, the optical module further includes an extinction wall 90. The extinction wall 90 may be made of a light-proof material (e.g., the same material as the masking layer 66 described above), may be made of a material that is able to block a specific wavelength, and etc. Some embodiments of the present disclosure may provide at least two substrates 10, at least two first reflective surfaces 20, at least two second reflective surfaces 30, and at least two exit surfaces 50. The extinction wall 90 is connected between any adjacent two substrates 10. For example, the extinction wall 90 is connected between the rounded side surfaces 60 of any adjacent two optical modules. The extinction wall 90 is configured to avoid the light from one of the adjacent two substrates 10 from entering into the other one of the adjacent two substrates 10. It is to be understood that, in case of two optical modules being provided, the substrate 10 of one of the two optical modules and the substrate 10 of the other one of the two optical modules are connected as a whole. One microdisplay 80 is disposed in each of the two optical modules, i.e., one microdisplay is disposed on the incident surface of each of the two optical modules. In some embodiments, one microdisplay may correspond to more than one incident surface 40 and a height of the extinction wall 90 may be greater than or equal to a distance between the second reflective surface 30 and the exit surface 50, i.e., to avoid a crosstalk between light from any adjacent two substrates 10, thereby effectively reducing the formation of stray light.

As illustrated in FIG. 8 to FIG. 13, some embodiments of the present disclosure further provide a near-to-eye display device 200. The near-to-eye display device 200 includes a microdisplay 80 and the optical module mentioned in the embodiments above. The microdisplay 80 is disposed in the incident surface 40.

In an implementation, each of the above units or structures may be realized as an independent entity, or may be combined with each other to serve as a single entity or a number of entities. The specific implementation of each of the above units or structures may refer to the previous embodiments and will not be repeated herein. It is to be understood that, the near-to-eye display device 200 may further include, for example, a frame, a lens, a circuit board, a power supply, an infrared sensor, a gyroscope, a temperature sensor, and etc., which are the components configured to install or drive the near-to-eye display device 200 to work and will not be elaborated herein.

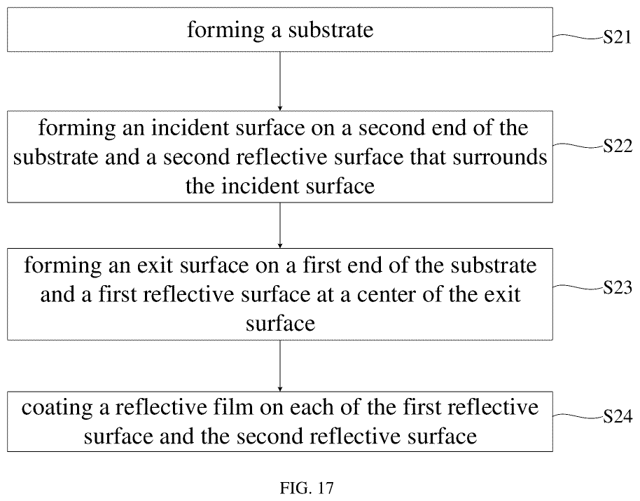

As illustrated in FIG. 17, some embodiments of the present disclosure further provide a processing method for the optical module, and the optical module may be the optical module mentioned in the above embodiments. The processing method for the optical module includes the following operations.

Operation S21: forming a substrate 10. In some embodiments, the substrate 10 may be formed through at least one of cutting, injection molding, and molding.

Operation S22: forming an incident surface 40 on a second end 14 of the substrate 10 and a second reflective surface 30 that surrounds the incident surface 40. In some embodiments, the incident surface 40 intersects the second reflective surface 30 at a first intersection line 122. At least one first distance d1 is defined between the first intersection line 122 and a periphery of the second reflective surface 30 along a first direction X. At least one second distance d2 is defined between the first intersection line 122 and the periphery of the second reflective surface 30 along a second direction Y. Each of the at least one first distance d1 is less than a corresponding one of the at least one second distance d2. In some embodiments, each of the exit surface 50 and the first reflective surface 20 may be one or a combination of a spherical surface, an aspherical surface, and a free-form surface.

Operation S23: forming an exit surface 50 on a first end 12 of the substrate 10 and a first reflective surface 20 at a center of the exit surface 50. In some embodiments, the exit surface 50 intersects the first reflective surface 20 at a second intersection line 124. At least one third distance d3 is defined between the second intersection line 124 and a periphery of the exit surface 50 along the first direction X. At least one fourth distance d4 is defined between the second intersection line 124 and the periphery of the exit surface 50 along the second direction Y. Each of the at least one third distance d3 is less than a corresponding one of the at least one fourth distance d4. In some embodiments, each of the incident surface 40 and the second reflective surface 30 may be one or a combination of a spherical surface, an aspherical surface, and a free-form surface. The first end is one end of the substrate and the second end is the other end of the substrate opposite to the first end. It is to be understood that, each of the corresponding spherical surface, the corresponding aspherical surface, and the corresponding free-form surface may be formed through cutting, injection molding, molding, and etc.

Operation S24: coating a reflective film on each of the first reflective surface 20 and the second reflective surface 30. In some embodiments, the reflective film may be coated on each of the first reflective surface 20 and the second reflective surface 30 through evaporating, sputtering, and etc. The incident surface 40 is configured to receive the light from an image of a microdisplay 80. The light enters the substrate 10 through the aspherical incidence surface 40, is reflected by the first reflective surface 20 and further reflected by the second reflective surface 30, and finally leaves or exits the substrate 10 through the aspherical exit surface 50. The above distance parameters may be controlled through cutting, injection molding, molding, and etc. Other descriptions of the optical module may refer to the above embodiments and will not be repeated herein.

Some embodiments of the present disclosure may further provide an optical substrate 10. The optical substrate 10 includes a first optical surface 12 and a second optical surface 14. The first optical surface 12 includes a first center portion 20 and a first peripheral portion 50. The first center portion 20 is coated with a reflective film. The first peripheral portion 50 surrounds the first center portion 20 and is free of a reflective film, i.e., is not coated with a reflective film. The second optical surface 14 is disposed in opposite to the first optical surface 12. The first optical surface 12 and the second optical surface 14 are located on a same optical axis Z. The second optical surface 14 includes a second center portion 40 and a second peripheral portion 30. The second center portion 40 is free of a reflective film, i.e., is not coated with a reflective film. The second peripheral portion 30 surrounds the second center portion 40 and is coated with a reflective film. The optical substrate 10 is configured to received light from an image through the second center portion 40. The light is reflected by the first center portion 20 and is further reflected by the second peripheral portion 30, and exits the optical substrate 10 through the first peripheral portion 50.

An optical module, a near-to-eye display device, a processing method for the optical module, and an optical substrate provided by some embodiments of the present disclosure are introduced in details above. Concrete examples are provided in the specification to describe the principles and the embodiments of the present disclosure. The above description of the embodiments is only used to help understand the method and the core ideas of the present disclosure. In addition, any person of ordinary skills in the art, based on the ideas of the present disclosure, may change the specific embodiments and the scope of application of the present disclosure. Therefore, the contents of the specification may not be understood as limitations on the present disclosure.

What is claimed is:

1. An optical module for a near-to-eye display device, comprising:
a substrate, comprising a first end and a second end disposed in opposite to the first end;
a first reflective surface, disposed on the first end of the substrate and configured to reflect light;
a second reflective surface, disposed on the second end of the substrate and configured to receive the light reflected by the first reflective surface and reflect the received light;
an incident surface, disposed on the second end of the substrate and surrounded by the second reflective surface, wherein the incident surface intersects the second reflective surface at a first intersection line, at least one first distance is defined between the first intersection line and a periphery of the second reflective surface along a first direction, at least one second distance is defined between the first intersection line and the periphery of the second reflective surface along a second direction, and each of the at least one first distance is less than a corresponding one of the at least one second distance;
an exit surface, disposed on the first end of the substrate and surrounding the first reflective surface, wherein the exit surface intersects the first reflective surface at a second intersection line, at least one third distance is defined between the second intersection line and a periphery of the exit surface along the first direction, at least one fourth distance is defined between the second intersection line and the periphery of the exit surface along the second direction, each of the at least one third distance is less than a corresponding one of the at least one fourth distance;
a rounded side surface, an end of the rounded side surface being connected to the second reflective surface and the other end of the rounded side surface being connected to the exit surface;
wherein the incident surface is configured to receive the light from an image of a microdisplay, the light enters the substrate through the non-planar incidence surface, is reflected by the first reflective surface and further reflected by the second reflective surface, and exits the substrate through the non-planar exit surface.

2. The optical module according to claim 1, wherein each of the incident surface, the exit surface, the first reflective surface, and the second reflective surface comprises one or a combination of a spherical internal reflection surface, an aspherical internal reflection surface, and a free-form internal reflection surface;
the first direction is perpendicular to the second direction, each of the at least one fourth distance is less than or equal to a corresponding one of the at least one second distance, and each of the at least one third distance is less than or equal to a corresponding one of the at least one first distance.

3. The optical module according to claim 1, wherein a length of one of two or more line segments defined between the intersection line and the periphery of the second reflective surface varies periodically, within a range between a corresponding one of the at least one first distance and a corresponding one of the at least one second distance, along a clockwise direction with respect to a circumference of the first intersection line;
a length of one of two or more line segments defined between the second intersection line the periphery of the exit surface varies periodically, within a range between a corresponding one of the at least one third distance and a corresponding one of the at least one fourth distance, along a clockwise direction with respect to a circumference of the second intersection line.

4. The optical module according to claim 1, wherein each of the incident surface, the first reflective surface, the second reflective surface, and the exit surface is curved towards a first direction of an optical axis.

5. The optical module according to claim 2, wherein the first reflective surface comprises a first vertex, the second reflective surface comprises a second vertex, the incident surface comprises a third vertex, and the exit surface comprises a fourth vertex;
the first vertex, the second vertex, the third vertex, and the fourth vertex are all located on an optical axis, the incident surface, the first reflective surface, the second reflective surface, and the exit surface are symmetrically arranged with respect to a cross section where the optical axis is located.

6. The optical module according to claim 3, wherein
a distance between the first vertex and the third vertex is less than or equal to 2.8 mm, a distance between the first intersection line and a line connecting the second vertex and the third vertex is less than or equal to 1.35 mm, a distance between the second intersection line and a line connecting the first vertex and the fourth vertex is less than or equal to 1.5 mm, a radius of each of the rounded side surface, the exit surface, and the second reflective surface is less than or equal to 3 mm, and a distance between the second intersection line and the periphery of the exit surface is greater than 0 and less than or equal to 1.6 mm.

7. The optical module according to claim 1, wherein on a plane perpendicular to an optical axis, a projected contour shape of the incident surface is similar to a projected contour shape of the first reflective surface and the projected contour shape of the second reflective surface is similar to a projected contour shape of the exit surface.

8. The optical module according to claim 1, wherein the optical module further comprises an outer flange, the outer flange is disposed on the periphery of the rounded side surface, the outer flange protrudes the rounded side surface, and the outer flange is configured to be cooperatively assembled with an external mechanism.

9. The optical module according to claim 8, wherein the outer flange further comprises at least one straight edge and the at least one straight edge is configured to cooperate with the external mechanism to position the substrate.

10. The optical module according to claim 1, wherein the optical module further comprises a masking layer, the masking layer covers the rounded side surface and is configured to block the light emitted from the microdisplay from transmitting to an exterior of the substrate through the rounded side surface.

11. The optical module according to claim 1, wherein the rounded side surface further comprises a first rounded surface and a second rounded surface, a circumference of the first rounded surface is smaller than a circumference of the second rounded surface, a first end of the first rounded surface is connected to the first reflective surface, a second end of the first rounded surface is connected to a first end of the exit surface, a second end of the exit surface is connected to a first end of the second rounded surface, and a second end of the second rounded surface is connected to the second reflective surface.

12. The optical module according to claim 11, wherein the masking layer disposed on the second rounded surface extends from the periphery of the exit surface along a direction away from the exit surface, and a distance between a center of the optical module and a projection of an end surface of the masking layer disposed on the second rounded surface on an optical axis is less than or equal to a distance between the center of the optical module and a projection of an end face of the first reflective surface on the optical axis.

13. The optical module according to claim 2, wherein each of the incident surface, the first reflective surface, the second reflective surface, and the exit surface is described by a polynomial sag equation.

14. The optical module according to claim 1, wherein a field of view of the optical module satisfies a formula:
$$F O V \geq ( \int {\int }_{θ , I} cos θ d θ dI ) \frac{{D}_{e y e}}{{f}_{e y e} min \{ {D}_{p} , {D}_{m} \}} , where , \frac{- {θ}_{e y e}}{2} \leq θ \leq \frac{{θ}_{e y e}}{2} , 0 \leq I \leq {I}_{e y e} ;$$
$$FOV \leq \frac{{D}_{e y e} {n}_{m}^{2} {S}_{1} {S}_{2}}{{f}_{e y e} min \{ {D}_{p} , {D}_{m} \} {n}_{e y e}^{2} {L}_{m}} ;$$
wherein FOV is a field of view, n_{eye} is a refractive index of an eyeball, Dₚ is an aperture diameter of a pupil, θ_{eye} is an angle of incidence on a retina, I_{eye} is a size of a retinal image, D_{eye} is a diameter of the eyeball, f_{eye} is a focal length of the eyeball, θₘ is an effective exit angle of the microdisplay, Dₘ is a maximum outer diameter of the optical module, S₁ is a diameter of the incident surface, S₂ is a diameter of the first reflective surface, and Lm is a thickness of the substrate.

15. The optical module according to claim 1, wherein the optical module further comprises an extinction wall;
at least two substrates, at least two first reflective surfaces, at least two second reflective surfaces, and at least two exit surfaces are arranged in the optical module;
the extinction wall is connected between any adjacent two substrates and the extinction wall is configured to block the light from one of the adjacent two substrates from entering into the other one of the adjacent two substrates.

16. The optical module according to claim 1, wherein the first direction is configured to correspond to an up-and-down orientation of a human eye and the second direction is configured to correspond to a left-and-right orientation of the human eye.

17. A near-to-eye display device, comprising:
a microdisplay, and
an optical module; wherein the optical module comprises:
a substrate, comprising a first end and a second end disposed in opposite to the first end;
a first reflective surface, disposed on the first end of the substrate and configured to reflect light;
a second reflective surface, disposed on the second end of the substrate and configured to receive the light reflected by the first reflective surface and reflect the received light;
an incident surface, disposed on the second end of the substrate and surrounded by the second reflective surface, wherein the incident surface intersects the second reflective surface at a first intersection line, at least one first distance is defined between the first intersection line and a periphery of the second reflective surface along a first direction, at least one second distance is defined between the first intersection line and the periphery of the second reflective surface along a second direction, and each of the at least one first distance is less than a corresponding one of the at least one second distance;
an exit surface, disposed on the first end of the substrate and surrounding the first reflective surface; wherein the exit surface intersects the first reflective surface at a second intersection line, at least one third distance is defined between the second intersection line and a periphery of the exit surface along the first direction, at least one fourth distance is defined between the second intersection line and the periphery of the exit surface 50 along the second direction, and each of the at least one third distance is less than a corresponding one of the at least one fourth distance;
a rounded side surface, an end of the rounded side surface being connected to the second reflective surface and the other end of the rounded side surface being connected to the exit surface;
wherein the incident surface is configured to receive the light from an image of a microdisplay and the microdisplay is disposed on the incident surface;
the light enters the substrate through the non-planar incidence surface, is reflected by the first reflective surface and further reflected by the second reflective surface, and exits the substrate through the non-planar exit surface.

18. The near-to-eye display device according to claim 17, wherein a length of one of two or more line segments defined between the intersection line and the periphery of the second reflective surface varies periodically, within a range between a corresponding one of the at least one first distance and a corresponding one of the at least one second distance, along a clockwise direction with respect to a circumference of the first intersection line;
a length of one of two or more line segments defined between the second intersection line the periphery of the exit surface varies periodically, within a range between a corresponding one of the at least one third distance and a corresponding one of the at least one fourth distance, along a clockwise direction with respect to a circumference of the second intersection line.

19. The near-to-eye display device according to claim 17, wherein the rounded side surface further comprises a first rounded surface and a second rounded surface, a circumference of the first rounded surface is smaller than a circumference of the second rounded surface, a first end of the first rounded surface is connected to the first reflective surface, a second end of the first rounded surface is connected to a first end of the exit surface, a second end of the exit surface is connected to a first end of the second rounded surface, and a second end of the second rounded surface is connected to the second reflective surface.

20. An optical substrate, comprising:
a first optical surface, comprising:
a first center portion, coated with a reflective film; and
a first peripheral portion, surrounding the first center portion and being free of a reflective film;
a second optical surface, disposed in opposite to the first optical surface, the first optical surface and the second optical surface being located on a same optical axis, the second optical surface comprising:
a second center portion, free of a reflective film; and
a second periphery portion, surrounding the second center portion and coated with a reflective film;
wherein the optical substrate is configured to receive light from an image through the second center portion, the light is reflected by the first center portion and further reflected by the second peripheral portion, and exits the optical substrate through the first peripheral portion.
